(19) United States
(12) Patent Application Publication
(10) Pub. No.: US 2013/0103745 A1
(43) Pub. Date: Apr. 25, 2013

(54) INFORMATION PROCESSING APPARATUS AND CONTROL METHOD THEREOF, AND COMPUTER-READABLE MEDIUM

(71) Applicant: Toshiyuki Nakazawa, Tokyo (JP)

(72) Inventor: Toshiyuki Nakazawa, Tokyo (JP)

(73) Assignee: CANON KABUSHIKI KAISHA, Tokyo (JP)

(21) Appl. No.: 13/616,388

(22) Filed: Sep. 14, 2012

(30) Foreign Application Priority Data
Oct. 21, 2011 (JP) 2011-232122
Dec. 13, 2011 (JP) 2011-272753

(51) Int. Cl. G06F 15/16

(52) U.S. Cl. 709/203

(57) ABSTRACT

An information processing apparatus, which provides a WEB page of an application program in response to a request, comprises a request unit configured to issue a request of a page to the application program before a request to the page via a network is received, and a management unit configured to compile the page in response to the request of the page by the request unit, and to hold and manages the compiled page in a cache.

### BACKGROUND OF THE INVENTION

1. Field of the Invention

The present invention relates to an information processing apparatus and control method thereof, and a computer-readable medium and, more particularly, to a cache control technique which can enhance access efficiency to a WEB server.

2. Description of the Related Art

As a conventional technique for enhancing access efficiency to a WEB server, it is a general practice to arrange a proxy with a cache function in the WEB server, WEB browser, or between the WEB server and WEB browser. Also, a given cache function control technique selectively stores contents, which are accessed at high probabilities from a WEB browser (for example, Japanese Patent Laid-Open No. 2000-137642).

Currently, a WEB application is often described using an interpreter language or intermediate language. The WEB server compiles codes described using the interpreter language or intermediate language at the time of execution, and holds a compile result in a cache. Then, the WEB server re-uses data held in the cache, thereby attaining efficient processing.

However, the conventional cache function compiles codes at the time of execution, and holds a compile result in the cache when it actually uses the compile result. At the first time of use, the user has to wait during compile processing.

### SUMMARY OF THE INVENTION

Hence, according to the present invention, even when a compile result of an initial page access or the like is to be used, the efficiency can be improved compared to the conventional technique.

According to one aspect of the present invention, there is provided an information processing apparatus, which provides a WEB page of an application program in response to a request, comprising: a request unit configured to issue a request of a page to the application program before a request to the page via a network is received; and a management unit configured to compile the page in response to the request of the page by the request unit, and to hold and manages the compiled page in a cache.

According to the present invention, a processing request is transferred prior to an access to a page which is required to be compiled at the time of execution such as codes described using the interpreter language or intermediate language. In the result, the present invention provides efficient accesses to such pages.

Further features of the present invention will become apparent from the following description of exemplary embodiments (with reference to the attached drawings).

### BRIEF DESCRIPTION OF THE DRAWINGS

FIG. 1 is a block diagram showing the overall arrangement of a system according to the first embodiment;

FIG. 2 is a block diagram showing the hardware arrangement of a host;

FIG. 3 is a flowchart showing the processing sequence of a cache control function;

FIG. 4 is a view showing an example of a part of a header of an HTTP request to be transferred by the cache control function;

FIG. 5 is a flowchart showing the processing sequence executed when a handler receives an HTTP request;

FIG. 6 is a chart showing the sequence of an HTTP request and response;

FIG. 7 is a block diagram showing the overall arrangement of a system according to the second embodiment;

FIG. 8A is a flowchart showing the processing sequence of a handler;

FIG. 8B is a flowchart showing the processing sequence of the handler when user authentication is not required;

FIG. 9 is a flowchart showing the sequence of access registration processing in step S801;

FIG. 10A is a table showing an example of access tally data managed by an access tally function;

FIG. 10B is a flowchart showing the sequence of page list acquisition processing of the access tally function;

FIG. 11A is a table showing an example of access tally data of an access tally function according to the third embodiment;

FIG. 11B is a flowchart showing the sequence of page list acquisition processing of the access tally function;

FIG. 12 is a block diagram showing the overall arrangement of a system according to the fourth embodiment;

FIG. 13 is a flowchart showing the sequence of tally processing of a tally function;

FIG. 14 is a flowchart showing the processing sequence of a cache control function; and

FIG. 15 is a flowchart showing the processing sequence of a cache control function according to the fifth embodiment.

### DESCRIPTION OF THE EMBODIMENTS

### First Embodiment

The best mode for carrying out the present invention will be described hereinafter with reference to the drawings.

[System Arrangement]

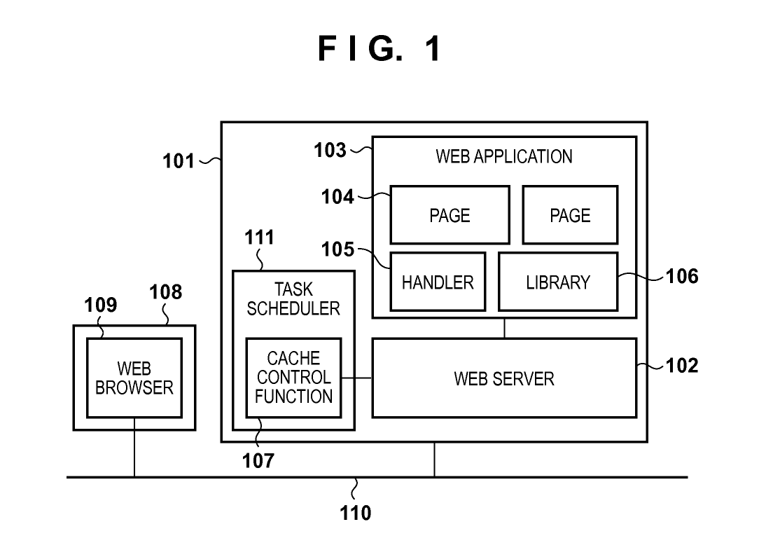

FIG. 1 is a block diagram showing an example of the arrangement of a system which includes a cache control unit according to the first embodiment of the present invention. In the system according to this embodiment, a terminal 108 as an information processing apparatus and a server 101 are connected via a network 110 to be able to communicate with each other. The server 101 includes a WEB server 102, a WEB application 103 and task scheduler 111, which run on the WEB server 102. The terminal 108 includes a WEB browser 109 required to access the WEB application 103.

Referring to FIG. 1, the server 101 is a host on which a cache control function 107, the WEB server 102, and the like run. The WEB application 103 as an application program runs on the WEB server 102. In this case, the WEB server 102 includes WEB application execution environments such as ASP.NET of Microsoft Corporation and Servlet Container of Java®. The WEB application 103 is configured by pages 104 which provide a user interface via the WEB browser 109, a library 106 called from the pages 104, and a handler 105 which hooks a request to the WEB server 102. The pages 104 in this case indicate those to be displayed via the WEB browser 109.

The task scheduler 111 is a resident program required to execute a management task defined by the WEB application 103 according to a schedule. The management task describes information required to distribute network settings and an upgrade program to devices on the network, which are managed by the WEB application 103.

Furthermore, the task scheduler 111 has an additional cache control function which calls the pages 104 in the WEB application 103 according to a schedule. The WEB application 103 does not operate unless it receives an external HTTP (Hypertext Transfer Protocol) request from the WEB browser 109 or the like. Therefore, in order to execute specific processing at a scheduled time in the WEB application 103, a unit such as the task scheduler 111, which operates without any external request, is required. The cache control function 107 has a function of transferring a request to each page in the WEB application 103 via the WEB server 102. The cache control function 107 is provided as a function in the task scheduler 111, and is processed periodically under the control of the task scheduler 111 or during an idle time of processing of the task scheduler 111.

The WEB browser 109 is used when the user accesses the WEB application 103, and displays the pages 104 and the like. The terminal 108 is a host on which the WEB browser 109 runs. The network 110 connects the server 101 and terminal 108 so that they can communicate with each other, and is used as a communication channel of data communications made between the WEB browser 109 and WEB server 102.

Note that the arrangement of a computer to which the present invention is to be applied is not limited to this, and other units and functions may also be included. The server 101 may be configured by a single computer or a plurality of computers. Also, the functions of the WEB server included in the server are not particularly limited. Furthermore, a WEB browser having various functions is available, and is not particularly limited.

[Hardware Arrangement]

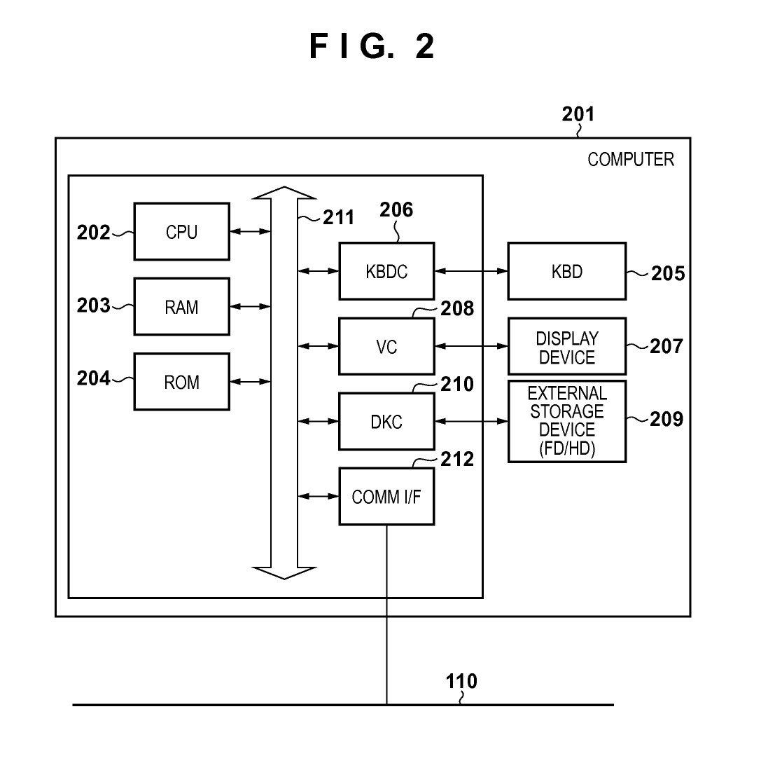

FIG. 2 is a block diagram showing an example of the hardware arrangement of the server 101 and terminal 108. In this case, the hardware arrangements of the server 101 and terminal 108 will be described together as that of a computer 201 below. Referring to FIG. 2, the computer 201 includes a CPU 202, RAM 203, ROM 204, and external storage device 209. The CPU 202 executes software stored in the ROM 204 and external storage device 209 or that downloaded via a LAN 213, and systematically controls respective devices connected to a system bus 211.

The RAM 203 functions as a main memory, work area, or the like of the CPU 202. The external storage device 209 includes a hard disk (HD), Floppy® Disk (FD), and the like. The external storage device 209 stores various applications including a boot program, operating system, database server, WEB server, WEB browser, database data, user files, and the like.

Furthermore, in the computer 201, a keyboard controller (KBDC) 206 transfers input information from a keyboard (KBD) 205 and pointing device (not shown) to the CPU 202. A video controller (VC) 208 controls display of a display device 207 including a CRT (Cathode Ray Tube), LCD (Liquid Crystal Display), or the like. A disk controller (DKC) 210 controls accesses to the external storage device 209. A communication controller (COMM I/F) 212 is connected to the network 110, thereby allowing communications with external apparatuses.

A cache is normally implemented by a fast accessible storage unit such as a register or memory. In this embodiment, a cache to be provided by the WEB server 102 is implemented on the RAM 203 included in the server 101, but the present invention is not limited to this.

[Operations of Components]

The operations of the components shown in FIG. 1 will be briefly described below. The pages 104 are described using a script language or interpreter language such as ASP.NET of Microsoft Corporation or JSP (Java Server Pages). The library 106 is provided using an intermediate language such as .NET of Microsoft Corporation or Java®. When the WEB browser 109 issues a first request to a given page 104, the WEB application 103 compiles the script language of the pages 104 and the intermediate language of the library 106. Then, the WEB application 103 processes the request using the compile result. The compile result is held in the cache by the WEB server 102. After that, in response to requests to the subsequent pages 104, the WEB application 103 can process the requests at high speed using the compile result held in the cache. The compile result managed by the WEB server 102 is discarded when the server 101 or WEB application 103 is restarted.

[Processing of Cache Control Function]

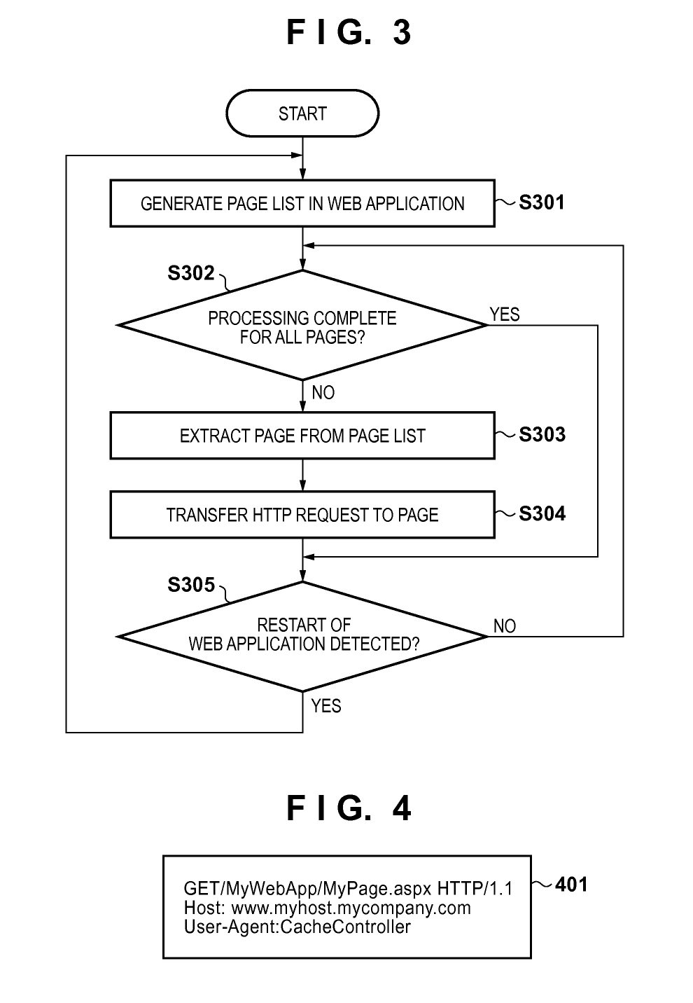

FIG. 3 is a flowchart showing the processing sequence of the cache control function 107. This processing is implemented when the CPU 202 included in the server 101 executes a program stored in the ROM 204 or the like as a storage unit.

The cache control function 107 generates a list of pages, which are required to be compiled, in the WEB application 103 in step S301. The cache control function 107 checks in step S302 whether or not processing is complete for all pages in the page list generated in step S301. If the processing is complete for all the pages (YES in step S302), the process of the cache control function 107 jumps to processes in step S305 and subsequent steps. If the processing is not complete for all the pages yet (NO in step S302), the cache control function 107 acquires one page to be processed in step S303. In step S304, the cache control function 107 issues and transfers an HTTP (or HTTPS) request to the acquired page. In this case, the cache control function 107 need not wait for a response from the WEB application 103.

Next, the cache control function 107 confirms in step S305 whether or not the WEB application 103 is restarted. If the WEB application 103 is restarted, the compile result managed by the WEB server 102 is discarded. If the WEB application 103 is restarted, page configurations in the WEB application 103 may often be changed. Therefore, if it is confirmed that the WEB application 103 is restarted (YES in step S305), the process returns to step S301 to acquire the list of pages, and the cache control function 107 executes the processes again from the beginning.

If it is not confirmed that the WEB application 103 is restarted (NO in step S305), the process returns to step S302, and the cache control function 107 continues processes for the next page to be processed included in the list. Note that after the processing is complete for all the pages acquired in step S301, the cache control function 107 repetitively detects the restart of the WEB application 103 in step S305.

[Authentication Processing]

Many generally used WEB applications require user authentication upon accessing respective pages in the WEB applications. When an access to a page that requires user authentication is made, and user authentication processing is not yet complete, the WEB application requests an HTTP request transfer source to transfer authentication information as in, for example, BASIC authentication. Alternatively, the WEB application returns a response required to transit to an authentication information input screen to an HTTP request transfer source.

When authentication processing in an HTTP protocol layer like BASIC authentication is used, the cache control function 107, which transfers an HTTP request, transfers authentication information, thus attaining user authentication. Thus, a target page is ready to be accessed.

The handler 105 is a module which executes authentication processing in response to an HTTP request from the cache control function 107 when the WEB application 103 is configured to display an authentication information input screen when user authentication is not complete.

A case will be described below wherein user authentication is required to access each page. Therefore, when user authentication is not required for a page access, processing to be described below need not be executed. In this embodiment, assume that user authentication is required in response to an HTTP request from the cache control function 107.

A description 401 shown in FIG. 4 indicates an example of a part of a header of an HTTP request, which is generated and transferred by the cache control function 107 and includes authentication information. In this case, upon transferring an HTTP request, the cache control function 107 designates [CacheController] in “User-Agent” of the HTTP header. This indicates that an HTTP request transfer source is the cache control function 107.

[Processing of Handler]

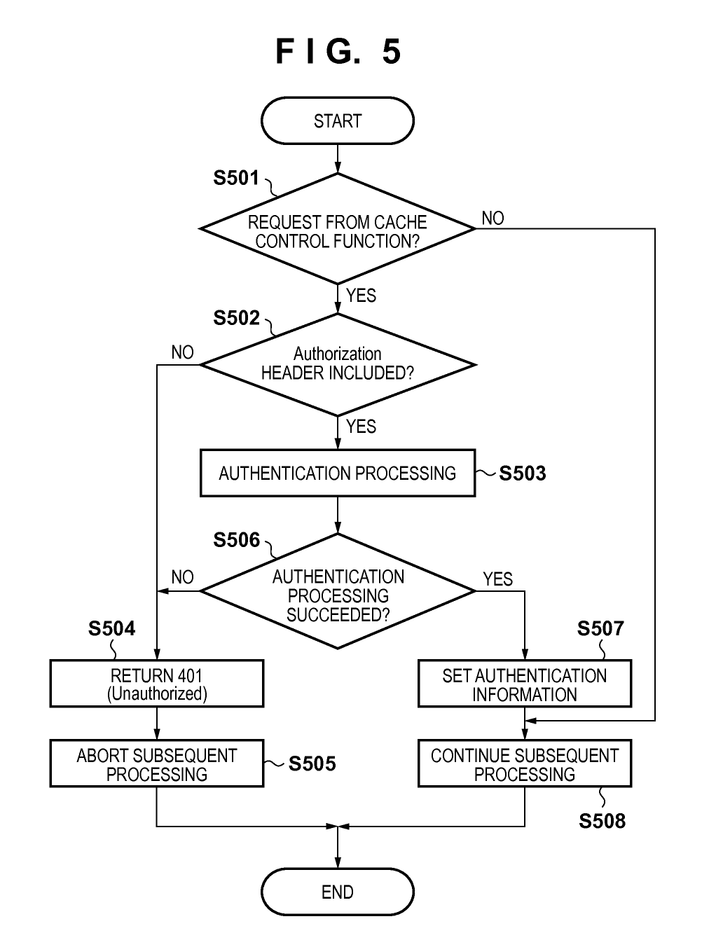

FIG. 5 is a flowchart showing the processing sequence executed when the handler 105 receives an HTTP request. This processing is implemented when the CPU 202 included in the server 101 executes a program stored in the ROM 204 or the like as a storage unit. The handler 105 is called from the WEB server 102 every time an HTTP request is received. Then, the handler 105 returns information as to whether subsequent processing is continued intact or processing is aborted to the WEB server 102 as the call side of the handler 105.

The handler 105 refers to “User-Agent” in a header of an HTTP request in step S501 to confirm whether or not the HTTP request is transferred from the cache control function 107. If “User-Agent” is [CacheController], the handler 105 judges that the HTTP request is transferred from the cache control function 107 (YES in step S501), and the process advances to step S502. If the request is not transferred from the cache control function 107 (NO in step S501), the process of the handler 105 jumps to step S508. Then, in step S508, the handler 105 instructs the WEB server 102 to continue subsequent processing, thus ending the processing. In this case, as the subsequent processing, for example, processing for providing a page compiled by the WEB server 102 to the terminal 108 or the like is assumed. When a compiled page is held on the cache, the WEB server 102 can reuse and provide that page without compiling the page again.

If the HTTP request is transferred from the cache control function 107 (YES in step S501), the handler 105 confirms in step S502 whether or not the HTTP request header includes an Authorization header. If no Authorization header is included (NO in step S502), the process of the handler 105 advances to step S504. In step S504, the handler 105 returns an HTTP response “401” (Unauthorized), which requests to re-transfer an HTTP request appended with authentication information, to the cache control function 107. After that, the handler 105 instructs the WEB server 102 to abort subsequent processing in step S505, thus ending this processing sequence.

If the HTTP request includes an Authorization header (YES in step S502), the handler 105 executes authentication using information in the header in step S503. Then, the handler 105 checks in step S506 whether or not the authentication has succeeded. If the authentication result indicates a failure (NO in step S506), the process of the handler 105 advances to step S504, and the handler 105 returns a response that requests authentication information to the cache control function 107. Then, the handler 105 instructs the WEB server 102 to abort subsequent processing in step S505, thus ending this processing sequence.

If the authentication result indicates a success (YES in step S506), the handler 105 sets the authentication information in the WEB server 102 and WEB application 103 in step S507. With this authentication information, the WEB server 102 and WEB application 103 can confirm that the received HTTP request has already been authenticated. After that, the handler 105 instructs the WEB server 102 to continue subsequent processing in step S508, thus ending this processing sequence. As the subsequent processing in this case, for example, processing of the WEB server 102 which compiles a requested page and holds the compile result in the cache is assumed.

[Response Sequence]

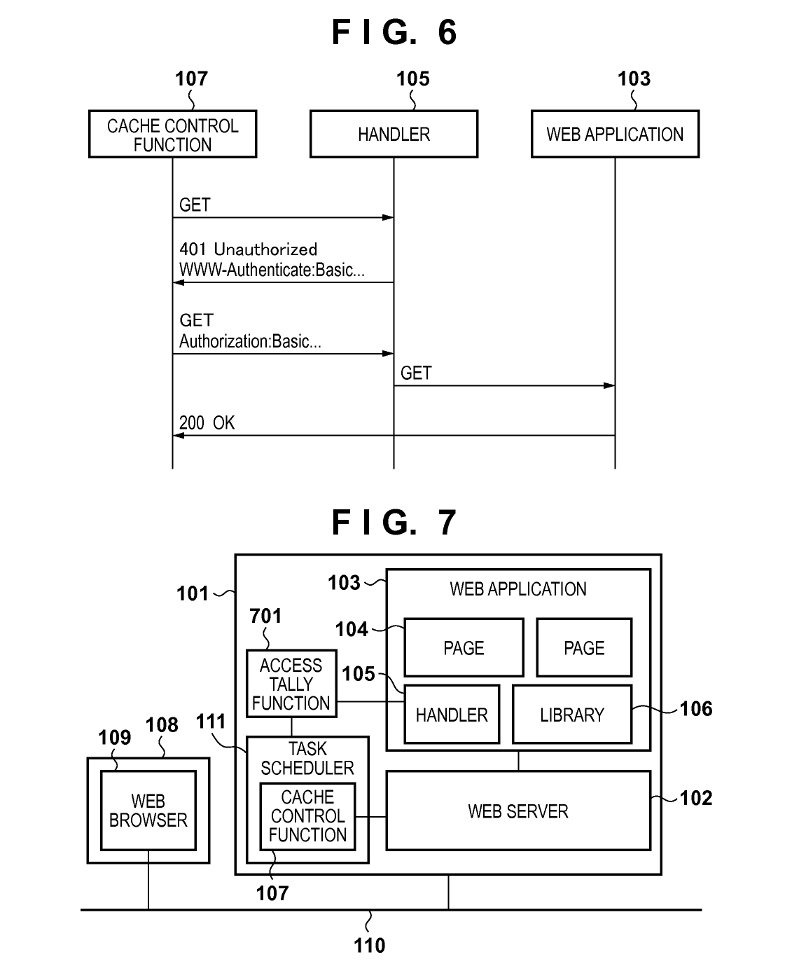

FIG. 6 shows the sequence of messages until an HTTP request transferred by the cache control function 107 is processed by the handler 105, WEB server 102, and WEB application 103, and a response to a requested page is returned. FIG. 6 does not show the WEB server 102 located between the cache control function 107 and handler 105 and between the handler 105 and WEB application 103, for the sake of simplicity.

An HTTP request, which is transferred by the cache control function 107 for a page that requires user authentication, as shown in FIG. 4, undergoes user authentication by the processes shown in FIGS. 5 and 6, and is then processed by the WEB application 103. Note that in this embodiment, as shown in FIGS. 5 and 6, a first HTTP request from the cache control function 107 does not include any authentication information, and a second HTTP request including authentication information is re-transferred. However, the first HTTP request may include authentication information, or user authentication processing itself may be skipped for an HTTP request from the cache control function.

As described above, according to this embodiment, an HTTP request is transferred in advance to pages which are required to be compiled at the time of execution, and compiled page data are cached, thus allowing efficient accesses to these pages.

### Second Embodiment

This embodiment can provide a list of pages with high access frequencies to the user in addition to the arrangement of the first embodiment.

FIG. 7 is a block diagram showing the overall arrangement of a system according to the second embodiment. The same reference numerals denote the same components as in FIG. 1. The arrangement shown in FIG. 7 newly includes an access tally function 701. Referring to FIG. 7, the access tally function 701 holds a list of all pages in the WEB application 103 and access counts to respective pages.

In this embodiment, the access tally function 701 provides the following three processes. The first processing is that for acquiring a list of pages in the WEB application 103. In this case, a page indicates dynamic resources (for example, JSP of Java® or aspx of ASP.NET), which are required to be compiled. The second processing is that for controlling an access counter of a page designated by an external call. The third processing is that for providing a list of pages in the WEB application 103, which are sorted in descending order of access counter value.

[Access Tally Data]

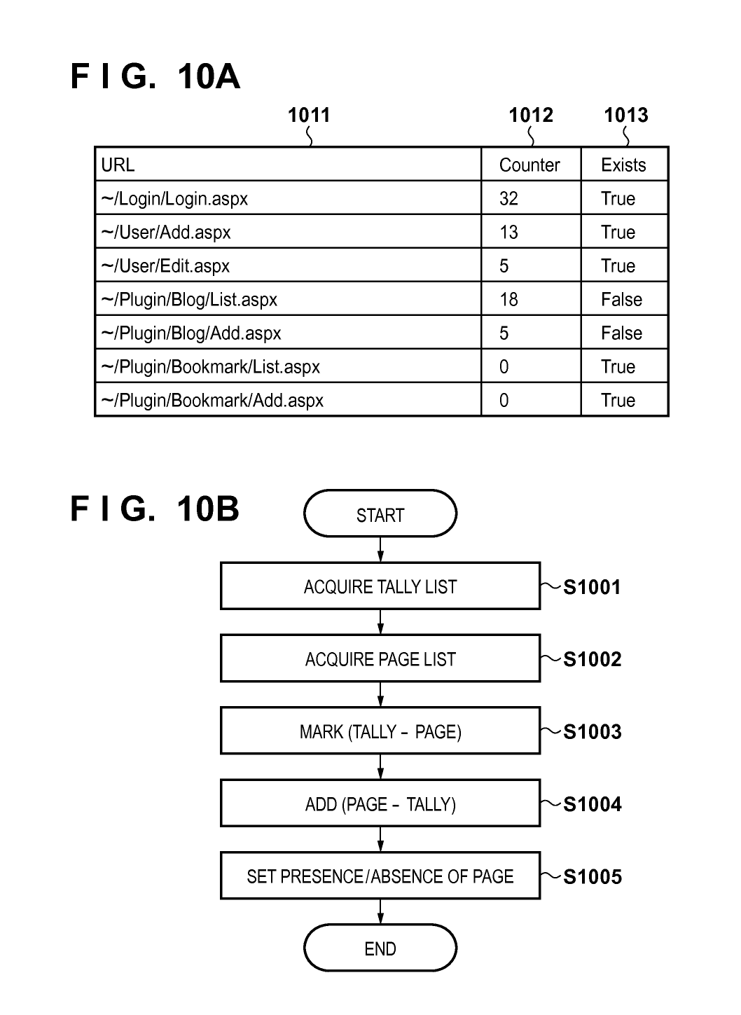

FIG. 10A shows an example of access tally data managed by the access tally function 701. The access tally data are saved in a storage device such as a file or database on the server 101, and the contents of the access tally data are held even when the WEB server 103 is restarted. In this case, the file or database is implemented by the external storage device 209 or the like included in the server 101. The access tally data include [page address], [access counter], and [presence/absence of page]. FIG. 10A shows them as “URL” 1011, “Counter” 1012, and “Exists” 1013.

The “URL” column 1011 holds addresses of pages, which are required to be compiled, in the WEB application 103. In FIG. 10A, [˜/] indicates a path of a root of the WEB application 103. The “Counter” column 1012 indicates the numbers of access times of pages designated by the page addresses. The “Exists” column 1013 indicates whether or not corresponding pages exist in the WEB application 103.

As a result of a change in configuration of the WEB application 103, when a given page in the WEB application 103 is deleted, and then the same page is added again, the value in the “Counter” field 1012 corresponding to that page is not reset. Page list providing processing as the third processing of the access tally function 701 provides, to a processing call source, a list of addresses of pages which correspond to [True] in the “Exists” column 1013 and are sorted in descending order of access counter.

[Page List Acquisition Processing]

FIG. 10B is a flowchart showing the sequence of page list acquisition processing as the first processing of the access tally function 701. This processing is implemented when the CPU 202 included in the server 101 executes a program stored in the ROM 204 or the like as a storage unit.

The access tally function 701 generates a list of tally pages by loading the access tally data shown in FIG. 10A in step S1001. Next, the access tally function 701 acquires a list of pages which are required to be compiled in the WEB application 103 in step S1002. Assume that this list of pages is held by, for example, the WEB application 103.

The access tally function 701 sets, based on the two lists, [False] in [presence/absence of page] (Exists 1013) in the access tally data of a page, which is included in the list of tally pages and is not included in the list of pages, that is, a page which is included in only tally pages, in step S1003. Next, the access tally function 701 adds a page, which is included in the list of WEB pages and is not included in the list of tally pages, that is, a page which is included in only the list of pages, to the access tally data in step S1004. At this time, the access tally function 701 sets, for a page to be added, “0” in an access counter (Counter 1012) and [True] in [presence/absence of page] (Exists 1013). Finally, the access tally function 701 sets [True] in [presence/absence of page] (Exists 1013) in the access tally data of respective pages in the list of pages in the access tally data, that is, pages which are included in the list of pages in step S1005.

The page list acquisition processing shown in FIG. 10B is called and executed by the handler 105 or cache control function 107 when the WEB application 103 is restarted.

[Processing of Handler]

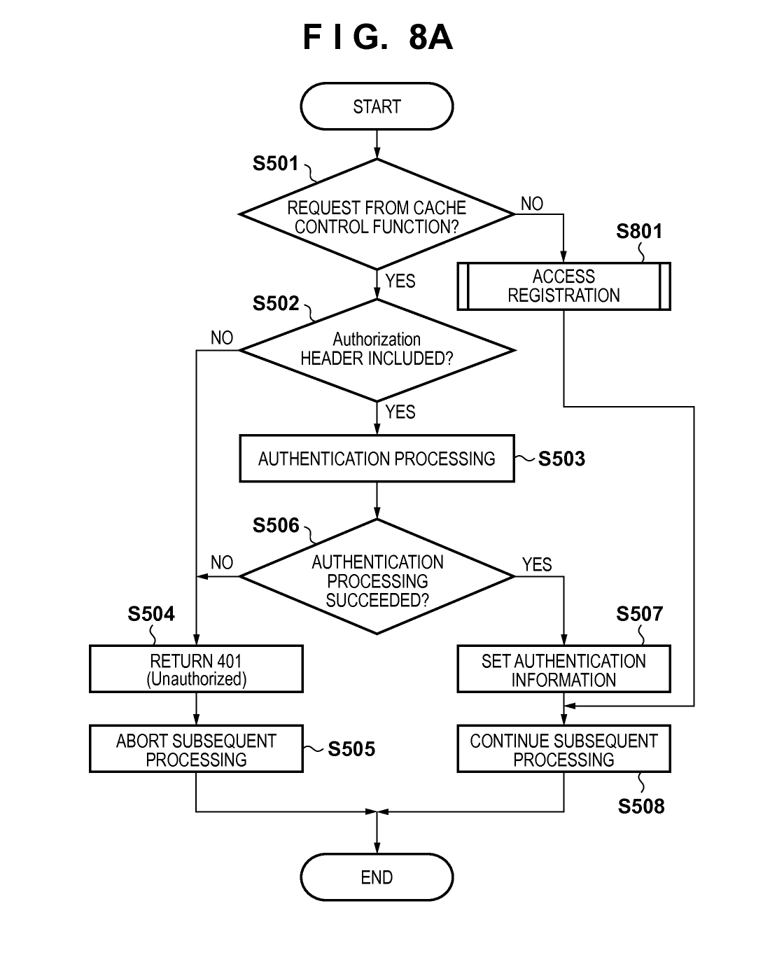

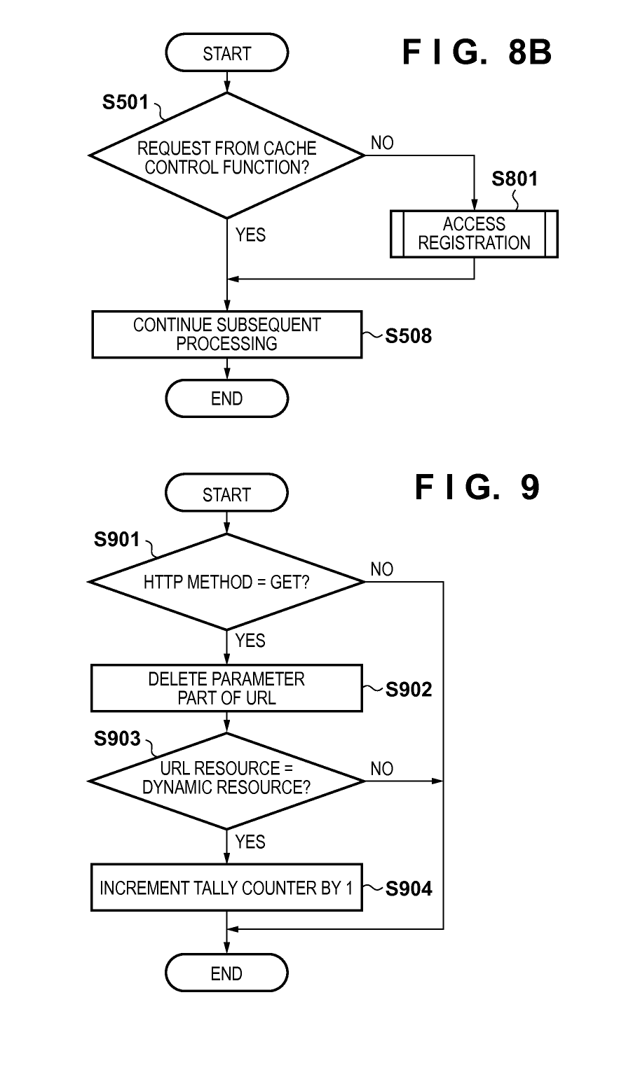

FIG. 8A is a flowchart showing the processing sequence of the handler 105. Since the processing sequence is the same as that shown in FIG. 5 except for processing for calling the access tally function 701 in response to a received HTTP request, and registering data in the access tally data, the same step numbers denote the same processes. Also, a detailed description of the same processes will not be repeated.

All HTTP requests transferred to the WEB application 103 are received by the WEB application 103, and are then processed in advance by calling the handler 105 from the WEB application 103.

The handler 105 confirms in step S501 whether or not a received HTTP request is transferred from the cache control function 107. If the HTTP request is transferred from the cache control function 107 (YES in step S501), the process of the handler 105 advances to the processes in step S502 and subsequent steps in FIG. 5. If the HTTP request is not transferred from the cache control function 107 (NO in step S501), the handler 105 executes access registration processing (to be described later) in step S801. After that, the process advances to step S508 in FIG. 5.

[Processing of Handler (when No User Authentication is Required)]

FIG. 8B is a flowchart showing the processing sequence of the handler 105 when an access to a page does not require any user authentication. This processing is implemented when the CPU 202 included in the server 101 executes a program stored in the ROM 204 or the like as a storage unit.

The handler 105 confirms in step S501 whether or not an HTTP request is transferred from the cache control function 107. If the HTTP request is not transferred from the cache control function 107 (NO in step S501), the handler 105 executes access registration processing in step S801. After that, the handler 105 instructs to continue subsequent processing in step S508.

[Access Registration Processing]

FIG. 9 is a flowchart showing the sequence of the access registration processing in step S801 in FIG. 8A or 8B. This processing is implemented when the CPU 202 included in the server 101 executes a program stored in the ROM 204 or the like as a storage unit.

The handler 105 confirms in step S901 whether or not an HTTP request method is [GET]. If a method is other than [GET] (NO in step S901), the handler 105 ends this processing without executing any processing. If the HTTP request method is [GET] (YES in step S901), the handler 105 deletes a parameter part which is not required for tally from a URL (Uniform Resource Locator) of the HTTP request in step S902. Note that the parameter part indicates a character string (query string) from [?] included in the URL.

Next, the handler 105 checks in step S903 whether a URL resource is a dynamic or static resource. Note that a static resource indicates a resource such as an image file, CSS file, or HTML file designated by the requested URL. Also, a dynamic resource indicates a resource such as JSP or aspx of ASP.NET, which is required to be compiled. As a result of checking, if the requested URL designates a static resource (NO in step S903), the handler 105 ends this processing without executing any processing. If the requested URL designates a dynamic resource (YES in step S903), the handler 105 calls the access tally function 701 to increment an access counter corresponding to the requested URL by “1” in step S904. Then, this processing ends.

[Processing of Cache Control Function]

Since the processing sequence of the cache control function 107 according to this embodiment is the same as that shown in the flowchart of FIG. 3 described in the first embodiment except for the following points, a description of redundant points will not be repeated.

The cache control function 107 of this embodiment calls processing for providing a list of pages in an access order of the access tally function 701 in the page list generation processing in step S301, thus generating a list of pages sorted in an access frequency order. Other processes are the same as those in respective steps in FIG. 3. In this case, in the processing shown in FIG. 3, HTTP requests may be preferentially transferred in descending order of access frequency.

As described above, according to this embodiment, a list of pages can be provided in consideration of access frequencies, and pages to be held by the cache can be controlled in addition to the effects of the first embodiment.

### Third Embodiment

A WEB server often executes compile processing for each directory where pages are allocated. For example, when three pages A, B, and C are allocated in a directory [X], the WEB server 102 executes compile processing for three pages A, B, and C in response to an access to any of pages A, B, and C, and saves the compile result in the cache.

In order to support such WEB server, the access tally function 701 of the second embodiment is modified to tally access counts for each directory where pages are allocated in the WEB application 103. The access tally function 701 then presents pages with larger access counts for respective directories.

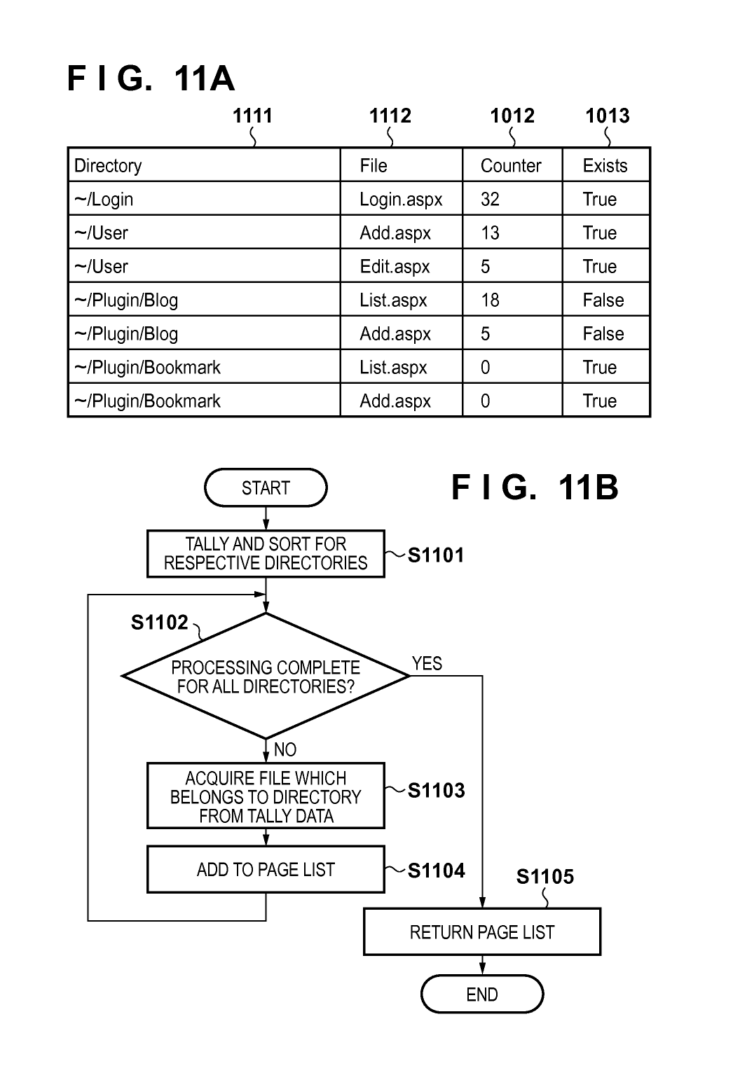

In this embodiment, the access tally function 701 divides URL parts of the access tally data shown in FIG. 10A in the second embodiment into directories and files, and holds them in a format shown in FIG. 11A. That is, the access tally data include “Directory” 1111 indicating file storage destinations, and “File” 1112 indicating file names as elements. Page list providing processing provides a list of pages in an order of directories with larger access counts by processing shown in FIG. 11B.

[Processing Sequence]

FIG. 11B is a flowchart showing the processing sequence executed when the access tally function 701 provides a page list in an order of directories with larger access counts. This processing is implemented when the CPU 202 included in the server 101 executes a program stored in the ROM 204 or the like as a storage unit.

The access tally function 701 generates list data including directories and totals of access counters for pages which belong to these directories for respective rows corresponding to [presence/absence of page]=[True] of the access tally data in step S1101. For example, in the example shown in FIG. 11A, the list data includes “32” for [˜/Login], “18” for [˜/User], and “0” for [˜/Plugin/Bookmark]. Next, the access tally function 701 sorts this data in descending order of total of access counters.

The access tally function 701 checks in step S1102 whether or not processing is complete for all directories in the list data. If the processing is complete for all the directories (YES in step S1102), the process advances to step S1105. If directories to be processed still remain (NO in step S1102), the process advances to step S1103.

In step S1103, the access tally function 701 extracts a file which belongs to a directory to be processed from this list. Then, the access tally function 701 generates a URL from a path of a directory of interest and a file name (“Directory” 1111 and “File” 1112). Next, the access tally function 701 adds the generated URL to the page list in step S1104, and tallies accesses to respective pages included in the directory. The access tally function 701 executes this processing for all the directories.

After the aforementioned processing is complete for respective directories in the list generated in step S1101 (YES in step S1102), the access tally function 701 returns the generated page list in step S1105.

With the aforementioned processing, the access tally function 701 generates a list of pages in an order of directories with higher access frequencies. In the example of FIG. 11A, the list includes [˜/Login/Login.aspx], [˜/User/Add.aspx], and [˜/Plugin/Bookmark/List.aspx]. Note that in the example of FIG. 11A, a [˜/Plugin/Blog] directory does not appear in the list since the value of “Exists” 1013 is [False].

Since other processes are the same as those in the second embodiment, a description thereof will not be repeated.

As described above, a list of pages in an access order for respective directories can be presented in addition to the effects of the first and second embodiments.

### Fourth Embodiment

This embodiment will explain an arrangement in which a WEB server incorporates a cache control function and access tally function.

[System Arrangement]

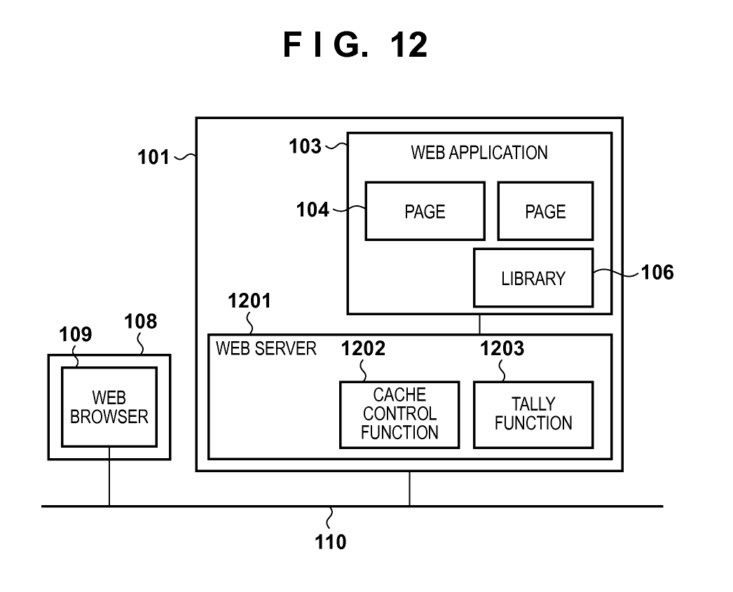

FIG. 12 is a block diagram showing the overall arrangement of a system according to this embodiment. The same reference numerals denote the same components as in FIG. 1. Referring to FIG. 12, a WEB server 1201 incorporates a cache control function 1202 and tally function 1203. The tally function 1203 is called by the WEB server 1201 every time an HTTP request to the WEB application 103 is received. Then, the tally function 1203 provides a function of tallying counts for respective pages of HTTP requests, and a function of returning a list of URIs (Uniform Resource Identifiers) of the WEB application 103 in descending order of access count based on the tally result.

[Tally Processing]

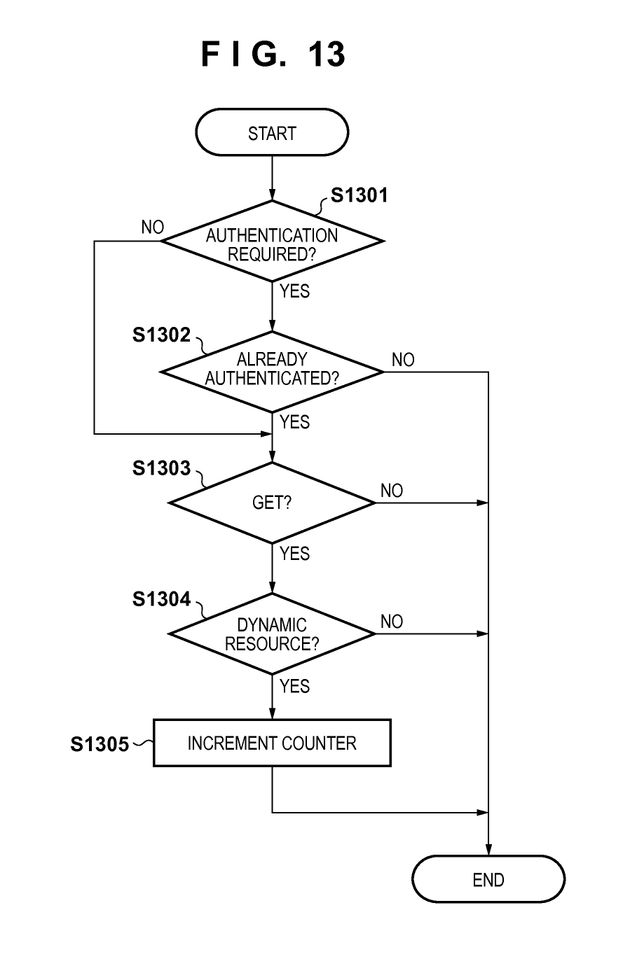

FIG. 13 is a flowchart showing the sequence of tally processing by the tally function 1203. This processing is implemented when the CPU 202 included in the server 101 executes a program stored in the ROM 204 or the like as a storage unit.

This tally processing is called by the WEB server 1201 every time an HTTP request to the WEB application 103 is received. The tally function 1203 checks in step S1301 whether or not a requested WEB page requires authentication. In case of a page which does not require any authentication (NO in step S1301), the process of the tally function 1203 jumps to step S1303.

In case of a page which requires user authentication (YES in step S1301), the tally function 1203 checks in step S1302 whether or not the HTTP request has already been authenticated. If the HTTP request has not been authenticated yet (NO in step S1302), the tally function 1203 ends processing. If the HTTP request has already been authenticated (YES in step S1302), the tally function 1203 checks in step S1303 whether or not an HTTP request method is [GET]. If the method is not [GET] (NO in step S1303), the tally function 1203 ends processing.

If the HTTP request method is [GET] (YES in step S1303), the tally function 1203 inspects in step S1304 whether or not the requested page includes a dynamic resource. If the requested page does not include any dynamic resource (NO in step S1304), the tally function 1203 ends processing. If the requested page includes a dynamic resource (YES in step S1304), the tally function 1203 increments an access counter corresponding to the requested page by “1” in step S1305. Then, this processing ends.

Access tally data used by the tally function 1203 and its page list acquisition processing are the same as those in FIGS. 10A and 10B described in the second embodiment, and a detailed description thereof will not be repeated.

[Processing of Cache Control Function]

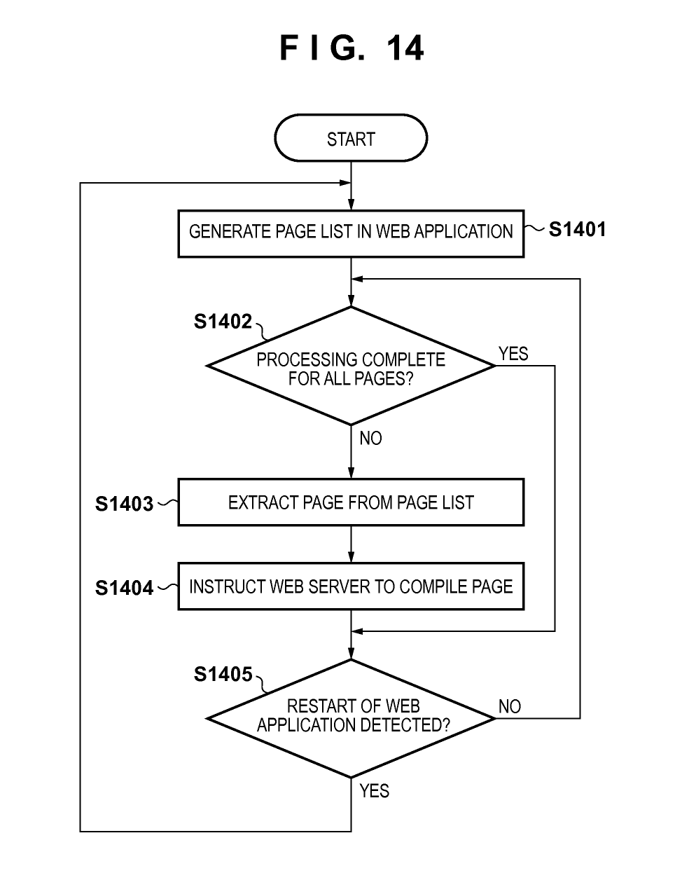

FIG. 14 is a flowchart showing the processing sequence of the cache control function 1202. This processing is implemented when the CPU 202 included in the server 101 executes a program stored in the ROM 204 or the like as a storage unit.

Note that the cache control function 1202 of this embodiment is incorporated in the WEB server 1201, as shown in FIG. 12, unlike the cache control function 107 of the second embodiment. At this time, since the WEB server 1201 includes WEB application execution environments, it incorporates a compile function of pages in the WEB application 103 and a cache function of the compile result. Therefore, the cache control function 1202 can directly call the compile function of pages and the cache function of the compile result, which functions are incorporated in the WEB server 1201. That is, unlike in the cache control function 107 of the second embodiment, the cache control function 1202 need not transfer an HTTP request required to cache page data to the WEB server 1201.

The cache control function 1202 calls the page list acquisition function of the tally function 1203 in step S1401, thereby acquiring a list of pages in an access frequency order in the WEB application 103. Then, the cache control function 1202 checks whether or not processing is complete for all pages included in the list. If the processing is complete for all the pages (YES in step S1402), the process jumps to step S1405. If pages to be processed still remain (NO in step S1402), the process advances to step S1403.

In step S1403, the cache control function 1202 extracts a page to be processed in descending order of access frequency from the page list. In step S1404, the cache control function 1202 requests the WEB server 1201 to execute compile processing of the page extracted in step S1403 and cache processing of that compile result. At this time, when the compile result of the designated page is not held in the cache, the WEB server 1201 compiles that page, and saves the compile result in the cache.

Next, the cache control function 1202 confirms in step S1405 whether or not the WEB application 103 is restarted. If it is confirmed that the WEB application 103 is restarted (YES in step S1405), the process of the cache control function 1202 returns to step S1401 to redo processing from page list acquisition. If it is not confirmed that the WEB application 103 is restarted (NO in step S1405), the process of the cache control function 1202 returns to step S1402 to continue processing for the page list acquired in step S1401.

With the aforementioned processing, the same effects as in the first embodiment can be obtained.

### Fifth Embodiment

This embodiment provides, to the user, a function of preferentially generating a cache for a page added to the WEB server 1201 in addition to the arrangements of the second and third embodiments. This embodiment allows to generate a cache within a shorter period of time by providing a function of detecting whether or not the cache has already been generated by, for example, a user operation.

[Page List Acquisition Processing]

Since the sequence of page list acquisition processing according to this embodiment is the same as that in the flowchart of FIG. 10B described in the second embodiment except for the following points, a description of redundant points will not be repeated.

The access tally function 701 of this embodiment changes an access counter of each page whose access counter (“Counter” 1012)=“0” to “1” when it generates a list of tally pages by loading access tally data shown in FIG. 10A in step S1001. With this processing, in the tally processing results of the page list shown in FIG. 10B in this embodiment, an access counter of a newly added page assumes “0”, and an access counter of each existing page assumes a value not less than “1”.

In processing of the access tally function 701 which provides a list of pages in an access order according to this embodiment, pages whose access counter=“0” are sorted to upper positions of the list. Then, a list of pages whose access counter=“1” or more and which are sorted in descending order of access counter is added to the pages whose access counter=“0”. Then, the access tally function 701 returns the generated list data. Based on this list, when a newly added page exists, the cache control function 107 of this embodiment preferentially transfers an HTTP request from a newly added page. That is, an HTTP request is issued preferentially for pages which are sorted to upper positions of the list.

The access tally function 701 according to this embodiment executes the same processing when access counts are tallied for respective directories as in the fourth embodiment. For example, the access tally function 701 according to this embodiment generates list data by adding list data of directories in an access frequency order and pages which belong to these directories to a list of newly added directories in step S1101.

[Processing of Cache Control Function]

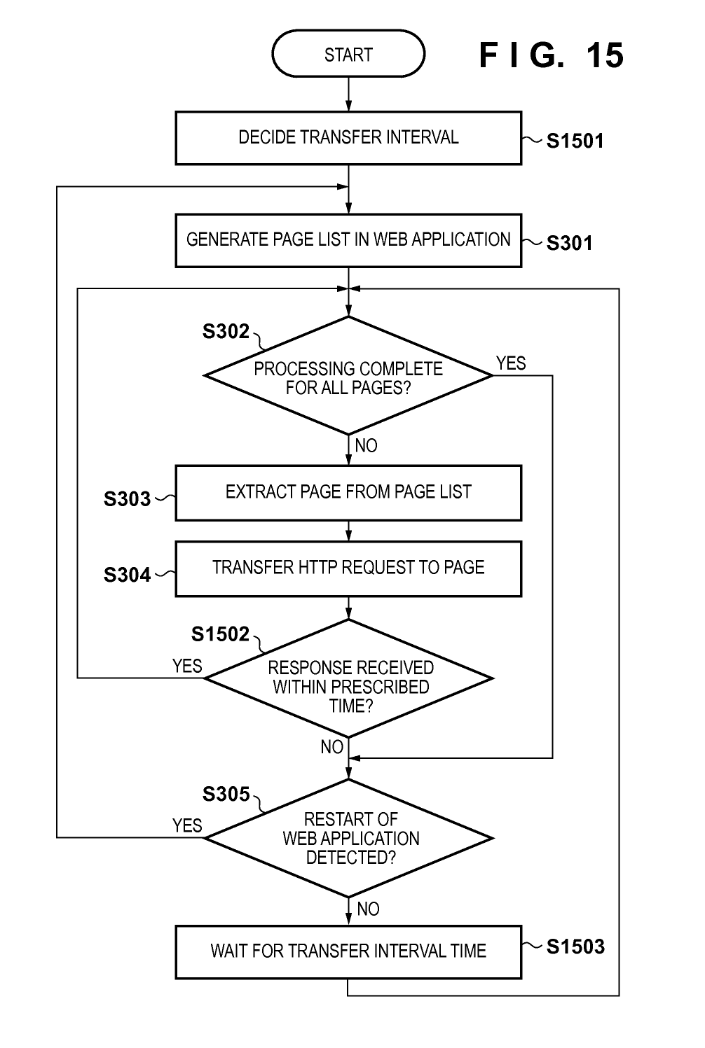

FIG. 15 is a flowchart showing the processing sequence of the cache control function 107 according to this embodiment. This processing is implemented when the CPU 202 included in the server 101 executes a program stored in the ROM 204 or the like as a storage unit. In FIG. 15, the same step numbers denote the same processes as those in the flowchart shown in FIG. 3, and a detailed description thereof will not be repeated.

In step S1501, the cache control function 107 decides a transfer interval of HTTP requests to pages in step S304. The transfer interval is decided based on, for example, the number of CPUs 202 included in the server 101 by:

Transfer interval (sec)=MIN(120,120/the number of CPUs)

According to this equation, when the number of CPUs is 1, the transfer interval is 120 sec; when the number of CPUs is 2, the transfer interval is 60 sec; or when the number of CPUs is four or more, the transfer interval is 30 sec.

The cache control function 107 transfers an HTTP (or HTTPS) request to an acquired page in step S304, and waits for a response from the WEB application 103. The cache control function 107 inspects in step S1502 whether or not an interval from transfer of the HTTP request in step S304 until reception of a response is longer than a prescribed value. As the prescribed value, a time which is longer than a response time expected when a cache of the page has already been generated and is shorter than a response time expected when the WEB server 102 generates a cache of the page is set. If the response time falls within the prescribed value range (YES in step S1502), the process of the cache control function 107 returns to step S302 to continue processing for pages to be processed included in the list. In this case, it can be judged that a cache for the page of interest has already been generated.

If the response time is longer than the prescribed value (NO in step S1502), the process of the cache control function 107 advances to restart detection processing of the WEB application 103 in step S305. If restart of the WEB application 103 is not detected (NO in step S305), the cache control function 107 waits in step S1503 for the transfer interval decided in step S1501. After an elapse of the transfer interval, the process of the cache control function 107 returns to step S302 to continue processing for the next page to be processed included in the list.

If restart of the WEB application 103 is detected (YES in step S305), the process returns to step S301.

With the aforementioned processing, when a page is added in the WEB server 1201, the function of preferentially generating a cache for the added page is provided to the user. Then, the cache can be generated within a shorter period of time by providing the function of detecting whether or not the cache has already been generated by a user operation or the like.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-232122, filed Oct. 21, 2011, and Japanese Patent Application No. 2011-272753, filed Dec. 13, 2011, which are hereby incorporated by reference herein in their entirety.

What is claimed is:

1. An information processing apparatus, which provides a WEB page of an application program in response to a request, comprising:
a request unit configured to issue a request of a page to the application program before a request to the page via a network is received; and
a management unit configured to compile the page in response to the request of the page by said request unit, and to hold and manages the compiled page in a cache.

2. The apparatus according to claim 1, wherein said request unit operates as a function of a scheduler which controls to execute tasks of the application program according to a schedule, and
the scheduler issues the request of the page to the application program.

3. The apparatus according to claim 1, wherein when a request of a page is transferred to the application program via a network and the page is held in the cache, the cached page is provided to a terminal connected to said information processing apparatus.

4. The apparatus according to claim 1, further comprising an authentication unit configured to execute authentication processing of said request unit when said request unit requests a page that requires user authentication.

5. The apparatus according to claim 1, wherein when said request unit detects restart of the application program, said request unit issues again a request of a page provided by the application program.

6. The apparatus according to claim 1, further comprising an access tally unit configured to tally access frequencies to pages,
wherein said request unit requests a page having a high access frequency of pages provided by the application program.

7. The apparatus according to claim 6, wherein said access tally unit tallies access frequencies for pages which are required to be compiled.

8. The apparatus according to claim 6, wherein said access tally unit tallies access frequencies for respective directories where pages are allocated.

9. The apparatus according to claim 1, wherein when a page provided by the application program is newly added, said request unit preferentially requests the newly added page.

10. A control method of an information processing apparatus, which provides a WEB page of an application program in response to a request, comprising:
a request step of issuing a request of a page to the application program before a request to the page via a network is received; and
a management step of compiling the page in response to the request of the page in the request step, and holding and managing the compiled page in a cache.

11. The method according to claim 10, wherein in the request step, a function of a scheduler which controls to execute tasks of the application program according to a schedule is operated, and
the scheduler issues the request of the page to the application program.

12. The method according to claim 10, wherein when a request of a page is transferred to the application program via a network and the page is held in the cache, the cached page is provided to a terminal connected to the information processing apparatus.

13. The method according to claim 10, further comprising an authentication step of executing authentication processing when a page that requires user authentication is requested in the request step.

14. The method according to claim 10, wherein in the request step, when restart of the application program is detected, a request of a page provided by the application program is requested again.

15. The method according to claim 10, further comprising an access tally step of tallying access frequencies to pages,
wherein in the request step, a page having a high access frequency of pages provided by the application program is requested.

16. The method according to claim 15, wherein in the access tally step, access frequencies for pages which are required to be compiled are tallied.

17. The method according to claim 15, wherein in the access tally step, access frequencies for respective directories where the pages are allocated are tallied.

18. The method according to claim 10, wherein in the request step, when a page provided by the application program is newly added, the newly added page is preferentially requested.

19. A non-transitory computer-readable medium storing a program for controlling a computer to function as respective units of claim 1.
